(19) United States
(12) Patent Application Publication
(10) Pub. No.: US 2009/0106753 A1
(43) Pub. Date: Apr. 23, 2009

(54) Method and apparatus for automatically installing operating system onto computer

(75) Inventors: Jun Wang, Beijing (CN); Ningting Cheng, Beijing (CN)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Lenovo (Beijing) Limited, Beijing (CN)

(21) Appl. No.: 12/286,051

(22) Filed: Sep. 26, 2008

(30) Foreign Application Priority Data
Sep. 29, 2007 (CN) 200710175474X

(51) Int. Cl. G06F 9/445

(52) U.S. Cl. 717/176

(57) ABSTRACT

The present invention provides a method and an apparatus of automatically installing an operating system onto a computer. The method is characterized in that: the computer establishes a connection with a remote server through a network; the computer sends configuration information to the remote server; the computer receives a corresponding installation script sent from the remote server based on the configuration information; and the computer installs the operation system according to the installation script. The present invention only requires performing updates of the installation script and various drivers in the remote server, which enables an automatic installation for various configurations of the computer. In addition, the present invention need not to allocate a navigation disc or other installation load discs to the computer, which saves the costs.

### BACKGROUND OF THE INVENTION

1. Field of Invention

The present invention relates to a computer management technique, and in particularly, to a method and an apparatus for automatically installing an operating system onto a computer.

2. Description of Prior Art

It has been a standard configuration provided by various manufacturers to perform automatic installation of an operating system onto a computer serving as a server, which helps to accomplish the installation for a person lacking in experience of the installation and to save time. There are two key points associated with the installation: first, an installation script needs to be written; second, various drivers need to be obtained while an operating system is being installed. These drivers are typically used to drive various devices in the server, such as Redundant Array of Independent Disk (RAID) cards, HUB cards, etc.

In prior art, a floppy disk is usually configured for a computer serving as a server. The floppy disk has an associated installation script and various drivers for enabling devices, which is used to work with an operating system installation disc in accomplishing the installation. Alternatively, a navigation disc is configured for a user, which has integrated installation scripts for common configuration of associated types of computers and various drivers for enabling devices. The disc can be used with an operating system installation disc to achieve the installation for the user, which is rapid, stable, and efficient.

However, there exist some defects in the above-mentioned prior art techniques. Once the configuration of a server has been changed, for example, a device is added or altered, and the installation script needs to be modified. Thus, the floppy disk or the navigation disc needs to be updated frequently if it is desired to be applied to various types of computers, which results in increasing of costs and difficulties of management. In addition, because the navigation disc is usually designed based on Linux, its kernel also needs to be updated frequently as the rapid hardware evolution so as to avoid non-compatibility between the kernel and the chipsets.

More information about aforesaid solutions can be found in following documents: U.S. Pat. No. 6,016,400, “Preloading software onto a computer system”; CN Patent No. 02153393.8, “Method for automatically installing an operating system by using Linux”.

### SUMMARY OF THE INVENTION

An object of the present invention is to provide a method and an apparatus of automatically installing an operating system onto a computer so as to solve the following problems in prior art: 1) a load medium such as a floppy disk or a navigation disc must be used together with an operating system installation medium to accomplish the installation of the operating system, which increases costs; 2) the load medium must be updated frequently on the client side.

There is provided a method of automatically installing an operating system onto a computer which is characterized in that: the computer establishes a connection with a remote server through a network; the computer sends configuration information to the remote server; the computer receives a corresponding installation script sent from the remote server based on the configuration information; and the computer installs the operating system according to the installation script.

Preferably, the installation script is searched for or customized by the remote server based on the configuration information from the computer.

Preferably, the method further comprises that: the computer receives corresponding drivers together with the installation script, the drivers are also sent from the remote server based on the configuration information.

Preferably, the computer receives the installation script and the drivers from the remote sever, stores the received installation script and drivers in a memory, and carries out the installation by cooperating with a local operating system in a local installation storage medium.

Preferably, the configuration information includes a host serial number of the computer.

Preferably, the configuration information further comprises configuration information of various components in the computer, in addition to the host serial number of the computer.

Preferably, a corresponding component list is firstly searched for by the remote server based on the host serial number contained in the configuration information, and then the installation script and drivers of the components are searched for by the remote server based on the component list.

Preferably, the installation script and drivers of various components are searched for by the remote server according to the configuration information of the components.

Preferably, the network is connected via a Basic Input Output System/Extensible Firmware Interface based on a network card driver; and the computer effectively communicates with the remote server by configuring environment-related network parameters.

There is also provided a method of automatically returning an installation script which is characterized in that: a remote server searches for or customizes a corresponding installation script based on a configuration information sent from a computer, in which the following steps are performed: step A: if the remote server finds an appropriate installation script according to a host serial number of the computer contained in the configuration information, the remote sever sends the installation script to the computer; otherwise it goes to step B; step B: the remote server carries out a match search based on configuration information of various components in the computer and if an appropriate installation script is found, the remote server sends the installation script to the client server; otherwise, it goes to step C; step C: the remote sever customizes an installation script according to the configuration information of the various components, and sends the installation script to the computer; if the customization is failed, the remote server notifies the computer that an appropriate installation script can not be found.

There is further provided a computer capable of automatically installing an operating system therein, comprising: means for establishing a connection with a remote server through a network; means for sending configuration information to the remote server; means for receiving a corresponding installation script sent from the remote server based on the configuration information; and means for installing the operating system according to the installation script.

Preferably, the means for receiving also receives corresponding drivers together with the installation script, the drivers are also sent from the remoter server based on the configuration information.

Preferably, the means for receiving receives the installation script and the drivers from the remote server, and stores the received installation script and drivers in a memory, and the computer carries out the installation by cooperating the received installation script and drivers with a local operating system in a local installation storage medium.

Preferably, the configuration information includes a host serial number of the computer.

Preferably, the configuration information further comprises configuration information of various components in the computer, in addition to the host serial number of the computer.

Preferably, the means for establishing connects the network via a Basic Input Output System/Extensible Firmware Interface based on a network card driver; and the means for establishing effectively communicates with the remote server by configuring environment-related network parameters.

There is still further provided a remote server capable of automatically returning an installation script, comprising: means for receiving configuration information sent from a computer; means for searching for or customizing a corresponding installation script based on the received configuration information, wherein the means for searching or customizing deals with the following cases: case a: if an appropriate installation script is found according to the received configuration information, returning the installation script; case b: if an appropriate installation script is not found according to the received configuration information, carrying out a match search based on configuration information of various components in the computer, and if an appropriate installation script is found, returning the installation script; case c: otherwise, customizing an installation script according to the configuration information of the various components, and returning the installation script; means for sending the returned installation script to the computer.

Preferably, if the means for searching or customizing fails the customization, it returns a message to indicate that an appropriate installation script can not be found, and the means for sending sends the returned message.

The present invention only requires performing updates of the installation script and various drivers in the remote server, which enables an automatic installation for various configurations of the client server (corresponding to the aforementioned computer). In addition, the present invention need not to allocate a navigation disc or other installation load discs to the client server, which saves the costs.

### BRIEF DESCRIPTION OF THE DRAWINGS

The preferred embodiments of the present invention are described below with reference to the drawings, in which:

FIG. 1 is a flow chart of installing an operating system in a client server with a standard configuration according to the present invention;

FIG. 2 is a flow chart of installing an operating system in a client server with a nonstandard configuration according to the present invention.

### DETAILED DESCRIPTION OF PREFERRED EMBODIMENTS

Now, the present invention will be elaborated with respect to the figures.

In the present invention, a network card driver is loaded into a Basic Input Output System/Extensible Firmware Interface (BIOS/EFI) of a client server. If the client server is connected to a network, then it establishes a connection with a remote server on its startup. After startup, the client server extracts information of components and corresponding configuration information from the components, and sends the information to the remote server. The remote server generates an installation script and drivers based on aforesaid information, and sends them to the client server.

The principle of above-mentioned procedure will be further described by following preferred embodiments.

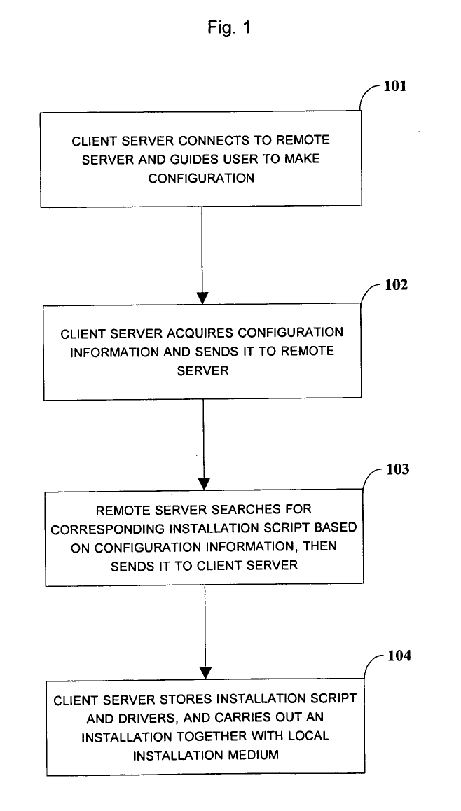

Due to the implementation of EFI, it is possible to load drivers before install an operating system. A network card driver is loaded into BIOS/EFI of a client server. When the configuration of the client server is a standard one, that is, the configuration information of the client server has been stored in the remote server, the client server establishes a connection with the remote server, downloads an installation script and even drivers, as well as carries out an installation together with a local operating system installation medium. The detail process is as shown in FIG. 1, and includes:

Step 101. A client server is powered on. Then, a network configuration interface is displayed which guides users friendly to perform a network configuration such that the client server can establish a stable connection with the remote server through the network card driver.

Step 102. The client server extracts configuration information of various components, a host serial number (SN), and the configuration information of the client server defined by users, for example, an IP address, a local network gateway, etc. Then, the client server sends aforesaid information to the remote server.

After a successful connection with the remote server, the above-mentioned configuration information of the client server is used by the client server to prompt users to select and input the associated configuration information of an installation of an operating system, such as the type of an operating system to be installed.

The configuration information of various components extracted by the client server is, for example, the types and serial numbers of the various components extracted from a System Management Basic Input/Output System (SMBIOS).

Step 103. An installation script corresponding to a standard configuration has been stored in the remote server since the configuration of the client server is a standard configuration. Therefore, the remote server can query the particular configuration of the client server, for example, the type of Redundant Array of Independent Disk and the type of mainboard, from a configuration database according to the configuration information sent by the client server such as the type of an operating system and serial numbers in SMBIOS. In a driver database, a component driver is searched for based on the configuration information and OS information. In a script database, an appropriate installation script is searched for based on the configuration information and OS information.

The database can also be lists which are generally called component lists. The remote server sends the installation script and drivers adapted for the client server to the client server through the network.

Step 104. The client server stores the installation script and drivers received from the remote server. It can be stored in a random access memory (RAMDISK) so as to be used together with a local installation medium for installing an operating system.

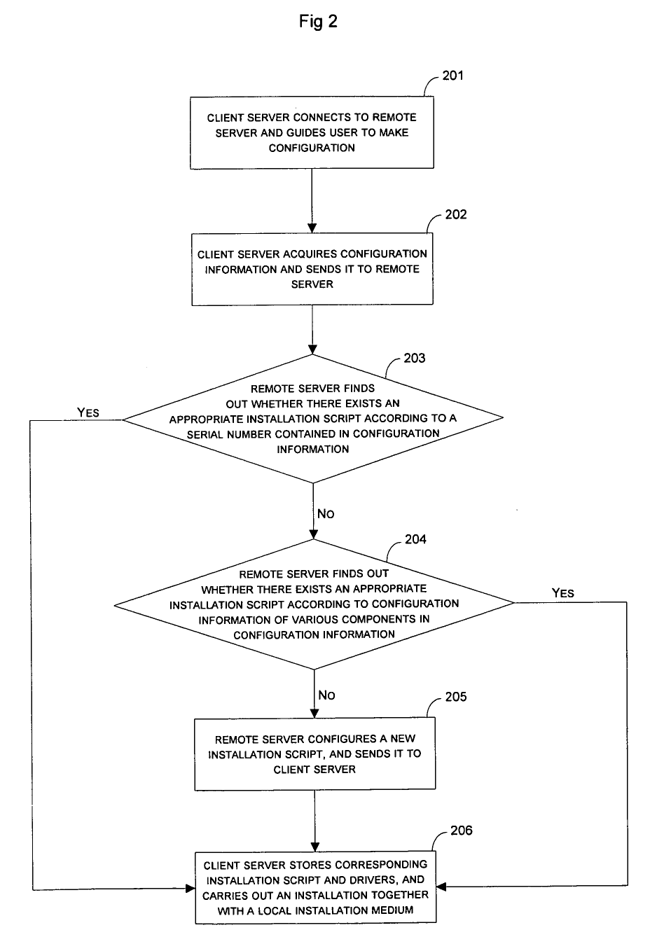

Above description involves a case where the configuration of the client server is a standard configuration. That is, above description relates to such an embodiment which steps will be employed by the client server to install an OS and various drivers when the configuration information of the client server has been stored in the remote server. In fact, during the lifetime of a client server, due to costs, performance, compatibility, need for update, the users may replace some components which results in the new components are different from original ones so that the corresponding installation scripts can not be found in the remote server. Hereunder, a solution aiming at solving problems which appear at the time an operating system is being installed in a client server with a nonstandard configuration will be explained. The detail process is shown in FIG. 2.

Step 201. A client server is powered on. Then, a network configuration interface is displayed which guides users friendly to perform a network configuration such that the client server can establish a stable connection with the remote server through the Step 202. The client server extracts configuration information of various components thereof and the configuration information of the client server defined by users. Then, the client server sends aforesaid information to the remote server.

After a successful connection with the remote server, the above-mentioned configuration information of the client server is used by the client server to prompt users to select and input the associated configuration information of an installation of an operating system, such as the type of an operating system to be installed.

The configuration information extracted by the client server comprises: serial numbers included in SMBIOS; the types of components such as a mainboard, a video card, and a sound card; and the types of chipsets of various components, etc.

The client server sends the configuration information to the remote server.

Step 203. The remote server searches for a component list corresponding to the serial number contained in the configuration information in the server, in order to find out whether an appropriate installation script is stored in the component list. If the serial number is matched, then the configuration information can be further compared. For example, for the same series of components, the chipsets used by these components are usually compatible. Therefore, the same installation script could be used even if some components are replaced by new ones in the client server. When the new components are not in accordance with original ones so that the remote server can not find an appropriate installation script corresponding to the serial number, it goes to step 204.

Step 204. The remote server carries out a match search in a component list based on the configuration information of various components. In a driver database, a component driver is searched for based on the configuration information and OS information. In a script database, an appropriate installation script is searched for based on the configuration information and OS information.

Step 205. If an appropriate installation script can not be found in both cases, the remote server can perform different methods, for example:

(1) prompting the client server that the remote server does not find an appropriate installation script, which may be caused by an error of input configuration information or a network failure; users may contact with an administer and prompt he/she to update the remove server.

(2) Configuring a new installation script based on the particular data in configuration information, sending the script to the client server, and storing it in the script database as a backup.

Step 206. The client server can store the corresponding installation script and drivers received from the remote server, for example, in a random access memory (RAMDISK), in order to carry out an installation together with a local installation medium.

The present invention only requires performing updates in the remote server, which ensures a flexible customization and enables an automatic installation for all the configurations. In addition, the present invention need not to allocate a navigation disc or other installation load discs to the client server, which saves the costs.

Although some embodiments of the present invention have been shown and described, it will be appreciated by those skilled in the art that many improvements and changes can be made without departing from the principles and spirits of the invention. The improvements and changes shall fall into the scope of the invention which is defined by the following claims.

1. A method of automatically installing an operating system onto a computer which is characterized in that:
the computer establishes a connection with a remote server through a network;
the computer sends configuration information to the remote server;
the computer receives a corresponding installation script sent from the remote server based on the configuration information; and
the computer installs the operating system according to the installation script.

2. The method according to claim 1, wherein the installation script is searched for or customized by the remote server based on the configuration information from the computer.

3. The method according to claim 1, further comprising that:
the computer receives corresponding drivers together with the installation script, the drivers are also sent from the remoter server based on the configuration information.

4. The method according to claim 3, wherein
the computer receives the installation script and the drivers from the remote server, stores the received installation script and drivers in a memory, and carries out the installation by cooperating with a local operating system in a local installation storage medium.

5. The method according to claim 1, wherein the configuration information includes a host serial number of the computer.

6. The method according to claim 5, wherein the configuration information further comprises configuration information of various components in the computer, in addition to the host serial number of the computer.

7. The method according to claim 6, wherein a corresponding component list is firstly searched for by the remote server based on the host serial number contained in the configuration information, and then the installation script and drivers of the components are searched for by the remote server based on the component list.

8. The method according to claim 7, wherein the installation script and drivers of various components are searched for by the remote server according to the configuration information of the components.

9. The method according to claim 1, wherein the network is connected via a Basic Input Output System/Extensible Firmware Interface based on a network card driver; and
the computer effectively communicates with the remote server by configuring environment-related network parameters.

10. A method of automatically returning an installation script which is characterized in that:
a remote server searches for or customizes a corresponding installation script based on configuration information sent from a computer, in which the following steps are performed:
step A: if the remote server finds an appropriate installation script according to a host serial number of the computer contained in the configuration information, the remote sever sends the installation script to the computer; otherwise, it goes to step B;
step B: the remote server carries out a match search based on configuration information of various components in the computer, and if an appropriate installation script is found, the remote server sends the installation script to the client server; otherwise, it goes to step C;
step C: the remote server customizes an installation script according to the configuration information of the various components, and sends the installation script to the computer; if the customization is failed, the remote server notifies the computer that an appropriate installation script can not be found.

11. A computer capable of automatically installing an operating system therein, comprising:
means for establishing a connection with a remote server through a network;
means for sending configuration information to the remote server;
means for receiving a corresponding installation script sent from the remote server based on the configuration information; and
means for installing the operating system according to the installation script.

12. The computer according to claim 11, wherein the means for receiving also receives corresponding drivers together with the installation script, and the drivers are also sent from the remote server based on the configuration information.

13. The computer according to claim 12, wherein the means for receiving receives the installation script and the drivers from the remote server, and stores the received installation script and drivers in a memory, and the computer carries out the installation by cooperating the received installation script and drivers with a local operating system in a local installation storage medium.

14. The computer according to claim 11, wherein the configuration information includes a host serial number of the computer.

15. The computer according to claim 14, wherein the configuration information further comprises configuration information of various components in the computer, in addition to the host serial number of the computer.

16. The computer according to claim 11, wherein the means for establishing connects the network via a Basic Input Output System/Extensible Firmware Interface based on a network card driver; and
the means for establishing effectively communicates with the remote server by configuring environment-related network parameters.

17. A remote server capable of automatically returning an installation script, comprising:
means for receiving configuration information sent from a computer;
means for searching for or customizing a corresponding installation script based on the received configuration information,
wherein the means for searching or customizing deals with the following cases:
case a: if an appropriate installation script is found according to the received configuration information, returning the installation script;
case b: if an appropriate installation script is not found according to the received configuration information, carrying out a match search based on configuration information of various components in the computer, and if an appropriate installation script is found, returning the installation script; and
case c: otherwise, customizing an installation script according to the configuration information of the various components, and returning the installation script; and
means for sending the returned installation script to the computer.

18. The remote server according to claim 17, wherein if means for searching or customizing fails the customization, it returns a message to indicate that an appropriate installation script can not be found, and the means for sending sends the returned message.
